(19) United States
(12) Patent Application Publication
(10) Pub. No.: US 2026/0086749 A1
(43) Pub. Date: Mar. 26, 2026

(54) INFORMATION PROCESSING APPARATUS, INFORMATION PROCESSING SYSTEM, AND METHOD FOR CONTROLLING INFORMATION PROCESSING APPARATUS

(71) Applicant: CANON KABUSHIKI KAISHA, Tokyo (JP)

(72) Inventor: MASASHI OHNO, Kanagawa (JP)

(21) Appl. No.: 19/332,215

(22) Filed: Sep. 18, 2025

(30) Foreign Application Priority Data
Sep. 25, 2024 (JP) 2024-166563

(51) Int. Cl. G06F 3/12

(52) U.S. Cl. CPC G06F 3/1259; G06F 3/1205; G06F 3/1245

(57) ABSTRACT

The information processing apparatus comprising: one or more memory devices that store a set of instructions; and one or more processors that execute the set of instructions to: obtain user information; and output information for forming an image, based on the user information obtained, wherein the information for forming an image includes at least one of first information set in a tenant that includes a plurality of image forming apparatuses and that can be used by a user, second information associated with the user, and third information indicating a state of an image forming apparatus included in the tenant.

### BACKGROUND

### Field of the Technology The present disclosure relates to an information processing apparatus, an information processing system, and a method for controlling an information processing apparatus.

### Description of the Related Art

Cloud print systems are being developed in which a printing service provided in the cloud and an image forming apparatus such as a printer or a digital multifunction peripheral installed in a company or the like operate in conjunction with each other. Such a cloud print system provides a “push” print service in which any desired image forming apparatus can be designated from a terminal apparatus, and the image forming apparatus that receives an image forming job forms the corresponding image immediately. Alternatively, the system provides a “held” printing service in which the image forming job is first stored in the cloud print system, and an image forming apparatus designated by a user then executes the image forming job at the time desired by the user. Such a service can be selected by the user by operating a setting screen. Additionally, Japanese Patent Laid-Open No. 2018-92583, for example, proposes a technique for obtaining model information of a printer on a network and applying that information to a setting screen.

In such a cloud print system, there are cases where, for example, a container including a plurality of image forming apparatuses is set. Alternatively, an administrator may make settings pertaining to cloud printing for a predetermined user, for example. In such a case, ensuring that the user notices these settings is conceivable as a way to improve the usability. Alternatively, ensuring that the user notices the availability status of the image forming apparatus for which the user has obtained permission to use is conceivable as another way to improve the usability. However, ensuring the user notices such things is difficult with the model information described in Japanese Patent Laid-Open No. 2018-92583.

### SUMMARY

The present disclosure enables the realization of a new technique for improving the usability of a user forming an image in a cloud print system.

One aspect of the present disclosure provides an information processing apparatus comprising: one or more memory devices that store a set of instructions; and one or more processors that execute the set of instructions to: obtain user information; and output information for forming an image, based on the user information obtained, wherein the information for forming an image includes at least one of first information set in a tenant that includes a plurality of image forming apparatuses and that can be used by a user, second information associated with the user, and third information indicating a state of an image forming apparatus included in the tenant.

Another aspect of the present disclosure provides a method for controlling an information processing apparatus, the method comprising: obtaining user information; and outputting information for forming an image, based on the user information obtained, wherein the information for forming an image includes at least one of first information set in a tenant that includes a plurality of image forming apparatuses and that can be used by a user, second information associated with the user, and third information indicating a state of an image forming apparatus included in the tenant.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic diagram illustrating an image forming system according to one embodiment.

FIGS. 2A and 2B are diagrams illustrating the hardware configuration of each of apparatuses according to one embodiment.

FIG. 3 is a diagram illustrating the hardware configuration of each of apparatuses according to one embodiment.

FIG. 4 is a diagram illustrating the software configuration of an image forming apparatus according to one embodiment.

FIG. 5 is a diagram illustrating the software configuration of a cloud print service according to one embodiment.

FIG. 6 is a diagram illustrating the software configuration of information processing equipment according to one embodiment.

FIG. 7 is a flowchart illustrating a processing sequence according to one embodiment.

FIG. 8 is a diagram illustrating a display screen according to one embodiment.

FIGS. 9A to 9C are diagrams illustrating printer information according to one embodiment.

FIG. 10 is a flowchart illustrating a processing sequence according to one embodiment.

FIG. 11 is a diagram illustrating a display screen according to one embodiment.

FIGS. 12A and 12B are diagrams illustrating display screens according to one embodiment.

FIGS. 13A and 13B are diagrams illustrating display screens according to one embodiment.

FIG. 14 is a diagram illustrating a display screen according to one embodiment.

FIG. 15 is a diagram illustrating a display screen according to one embodiment.

FIG. 16 is a flowchart illustrating a processing sequence according to one embodiment.

FIG. 17 is a flowchart illustrating a processing sequence according to one embodiment.

FIGS. 18A and 18B are diagrams illustrating display screens according to one embodiment.

FIG. 19 is a diagram illustrating a display screen according to one embodiment.

FIG. 20 is a diagram illustrating a display screen according to one embodiment.

FIG. 21 is a diagram illustrating a display screen according to a variation.

FIG. 22 is a diagram illustrating printer information according to a variation.

FIG. 23 is a diagram illustrating tenant information according to a variation.

FIG. 24 is a diagram illustrating the software configuration of a cloud print service according to a variation.

FIG. 25 is a flowchart illustrating a processing sequence according to a variation.

FIG. 26 is a diagram illustrating a display screen according to a variation.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

Herein, the term “image forming apparatus” is assumed to refer broadly to any apparatus that forms (records) an image on a recording material (a recording medium), including single-function printers, copiers, multifunction peripherals, commercial printers, and the like. Note also that the term “print” as used herein may also be referred to as “forming an image”. Hereinafter, the “image forming apparatus” may also be referred to as a “printer” or a “device”.

### System Configuration

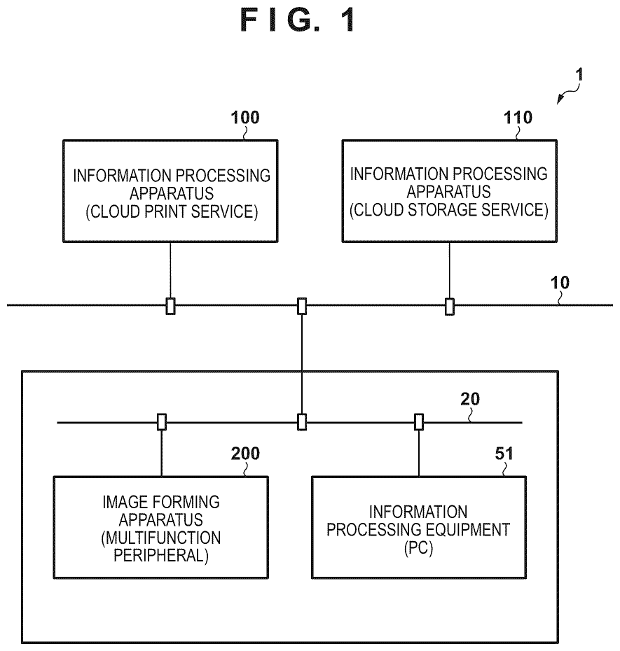

The configuration of an image forming system 1 (an example of an “information processing system”) according to the present embodiment will be described first with reference to FIG. 1. The image forming system 1 includes, for example, an information processing apparatus 100 (an example of an “information processing apparatus”), an information processing apparatus 110, information processing equipment 51, and an image forming apparatus 200, which are connected over a network 10 or 20. Here, in the image forming system 1, an administrator may manage a single image forming apparatus 200 or a plurality of image forming apparatuses 200 collectively through the information processing apparatus 100 in, for example, a company or an organizational unit belonging to a company. In such a case, this unit of management is also referred to as a “tenant”.

The information processing apparatus 100 is a server hosted on a cloud platform, and provides a web portal to connected clients. The information processing apparatus 100 in particular is provided with a service that provides printing-related services. Hereinafter, the information processing apparatus 100 may also be referred to as a “cloud print service 100”. The information processing apparatus 110 provides a general-purpose cloud storage service, such as Google Drive (registered trademark), for example. The information processing apparatus 110 may be referred to as a “cloud storage service 110” hereinafter.

The image forming apparatus 200 is a digital multifunction peripheral provided with a plurality of functions, such as a copy function, a scan function, a print function, a fax function, an email transmission function, and the like. The apparatus may instead be a printer provided with a single function. Although only one image forming apparatus 200 is illustrated in FIG. 1, the number of image forming apparatuses 200 is not limited to one.

The information processing equipment 51 is, for example, a personal computer (PC), but may be information processing equipment such as a smartphone, a tablet, or the like. A local network 20 is, for example, a network within a company office, and FIG. 1 illustrates an example in which a plurality of image forming apparatuses and information processing equipment used by a plurality of employees are connected within the company office.

The image forming apparatus 200 and the information processing equipment 51 are capable of communicating with the cloud print service 100 over the network 10, and are capable of using a web portal, a printing service, and the like provided by the cloud print service 100. Likewise, each image forming apparatus 200 is capable of communicating with the cloud storage service 110 over the network 10, and is capable of using a file service provided by the cloud storage service 110.

### Hardware Configuration of Image Forming Apparatus 200

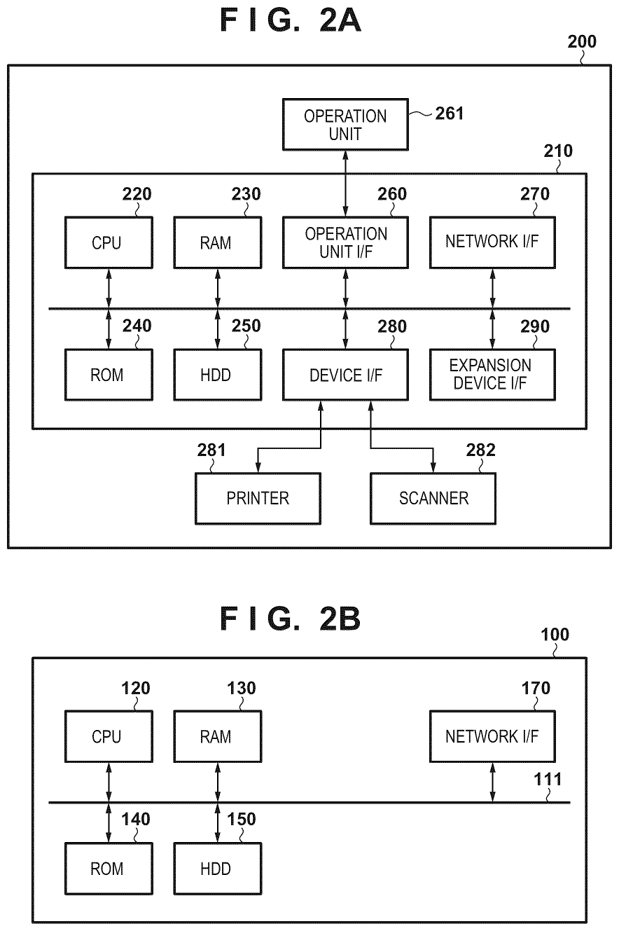

The hardware configuration of the image forming apparatus 200 will be described next with reference to FIG. 2A. The image forming apparatus 200 is a digital multifunction peripheral, for example, and is configured including a controller unit 210, an operation unit 261, a printer 281 (an example of an “image forming unit”), and a scanner 282. The controller unit 210 includes a CPU 220, a RAM 230, a ROM 240, an HDD 250, an operation unit I/F 260, a network I/F 270, a device I/F 280, and an expansion device I/F 290.

The CPU 220 is a unit that executes control programs provided in the image forming apparatus 200, and controls the operations of devices connected to the controller unit through the I/Fs and storage medium memory. Programs such as an operating system, system software, application software, and the like, as well as data, are stored in the RAM 230. A system boot program, system programs, application programs, and the like are stored in the ROM 240. Furthermore, information necessary for the image forming apparatus 200, such as fonts and the like, may be stored in the ROM 204 as well. The HDD 250 is a storage device having a larger capacity than the RAM 230, and stores an operating system, system software, application software, image data, setting data, print jobs, user information, and the like. Programs stored in the HDD 250 are loaded into the RAM 230 by the CPU 220 executing programs stored in the ROM 240. The CPU 220 then executes programs loaded into the RAM 230, and processes data stored in the RAM 230, the ROM 240, and the HDD 250. Some compact multifunction peripherals are configured without the HDD 250, and system software, application software, and the like are stored in the ROM 240 instead. Alternatively, the configuration may be such that a storage device other than a hard disk, such as Flash memory constituting a solid-state disk (SSD), is used instead of the HDD 250.

The operation unit I/F 260 is an interface unit that controls input/output with the operation unit 261, which includes a touch panel, for example, and outputs image data to be displayed in the operation unit 261 to the operation unit 261. The operation unit I/F 260 also communicates, to the CPU 220, input information resulting from a user operating the operation unit 261. The network I/F 270 (an example of a “third communication unit”) is configured including a communication module, connects to a network, and communicates with external devices on the network.

The device I/F 280 connects the printer 281, the scanner 282, and the like, which are image input and output devices, to the controller unit 210, and inputs and outputs image data. The CPU 220 reads a document image by controlling the scanner 282, and the read image data is stored in the RAM 230, the HDD 250, or the like through the device I/F 280. The stored image data is subjected to image processing by application programs loaded into the RAM 230 as necessary. The CPU 220 also prints the image data onto a sheet by outputting the image data to the printer 281 through the device I/F 280 and controlling the printer 281.

The expansion device I/F 290 is configured including a USB port, a wireless transceiver such as Bluetooth, or the like to enable any optional devices to be connected. The expansion device I/F 290 enables optional devices, such as an ID card reader, a biometric authentication device, or the like, to be connected to the image forming apparatus 200.

Note that the image forming apparatus 200 is not limited to the configuration illustrated in FIG. 2A. For example, the image forming apparatus 200 may be a printer that does not include the scanner 282. If the image forming apparatus 200 is a multifunction peripheral having a fax function, an I/F for a modem apparatus (not shown in FIG. 2A) may be provided in the controller unit 210, and the image forming apparatus 200 may be connected to a public line by the modem to transmit faxes.

### Hardware Configuration of Cloud Print Service 100

The hardware configuration of the cloud print service 100 will be described next with reference to FIG. 2B. The cloud print service 100 is configured including a CPU 120, a RAM 130, a ROM 140, an HDD 150, and a network I/F 170, which are connected to each other over a bus 111. The CPU 120 controls the overall operations by reading out control programs stored in the ROM 140 and executing various types of processing. The RAM 130 is used as the main memory of the CPU 120, a temporary storage region such as a work area, or the like. The HDD 150 is a high-capacity storage unit that stores image data, various types of programs, and the like. The network I/F 170 is configured including a communication module, and is an interface for connecting to the Internet. The network I/F 170 is an example of an “obtainment unit”, an “output unit”, and a “first communication unit capable of communicating with information processing equipment”. The hardware configuration of the cloud storage service 110 corresponds to the hardware configuration of the cloud print service 100 illustrated in FIG. 2B, for example, and will therefore not be described here.

### Hardware Configuration of Information Processing Equipment 51

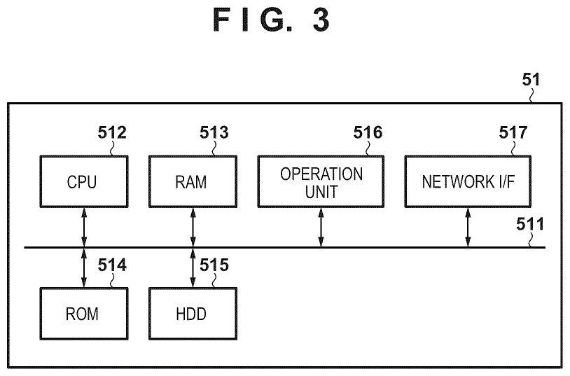

The hardware configuration of the information processing equipment 51 will be described next with reference to FIG. 3. The information processing equipment 51 is configured including a CPU 512, a RAM 513, a ROM 514, an HDD 515, an operation unit 516, and a network I/F 517, which are connected to each other over a bus 511. The CPU 512 controls the overall operations by reading out control programs stored in the ROM 514 and executing various types of processing. The RAM 513 is used as the main memory of the CPU 512, a temporary storage region such as a work area, or the like. The HDD 515 is a high-capacity storage unit that stores image data, various types of programs, and the like. The operation unit 516 is configured including an input device such as a keyboard and a mouse (an example of an “accepting unit”), and an output device such as a display (an example of a “display unit”). The operation unit 516 is an interface for inputting various operation signals to the information processing equipment 51 and displaying results of processing by the information processing equipment 51. The network I/F 517 (an example of a “second communication unit”) is an interface for connecting to the Internet, and is configured including a communication module.

### Software Configuration of Image Forming Apparatus 200

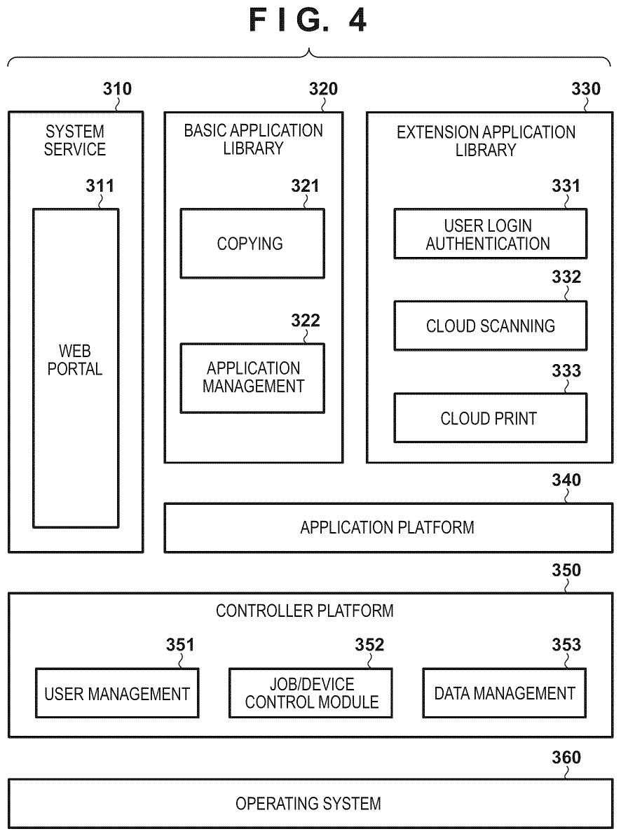

The software configuration of programs executed by the CPU 220 of the image forming apparatus 200 will be described next with reference to FIG. 4. An operating system 360 provides various resource management services and frameworks optimized for controlling embedded systems for software running thereon. Specifically, the various resource management services and frameworks include multi-task management for running multiple processes substantially in parallel by managing multiple execution contexts for processing by the CPU 220, and inter-task communication for implementing synchronization and data exchange between tasks. Furthermore, the operating system 360 provides memory management, interrupt management, various device drivers, and local interfaces, as well as a protocol stack that implements processing through various protocols such as network and communication protocols, and the like, for example.

A controller platform 350 is configured including user management 351, a job/device control module 352, and a data management module 353. The user management 351 provides applications with a mechanism for managing local users, and credentials thereof, in the image forming apparatus 200 using the RAM 230 or the HDD 250. A login application implements user login control for the image forming apparatus 200 using the local user credentials managed by the user management 351. The job/device control module 352 executes image forming jobs such as scanning, printing, and copying while controlling the printer 281 and the scanner 282 in accordance with instructions from applications. The states of devices such as the printer 281 and the scanner 282, errors in those devices, and the like are managed as well.

The data management module 353 manages image data and various types of setting data required when executing an image forming job. The data management module 353 also manages a job execution history, counter information, various types of data controlled by other applications, and configuration information and capability information of the image forming apparatus 200.

A system service 310 is a software module responsible for managing the controller platform 350 and operating system program updates, as well as device information/network settings and the like. Furthermore, the system service 310 is configured including a web portal 311, and can be operated from a remote terminal such as the information processing equipment 51.

An application platform 340 is middleware that can be used from various types of applications. Specifically, the operating system 360 and the mechanism of the controller platform 350 are configured to be usable from various types of applications in a basic application library 320 and an extension application library 330 (described later).

The basic application library 320 is a group of applications that provide the basic functions of the image forming apparatus 200, which are stored in the ROM 240 or the HDD 250 in an initial state at the time of purchase of the image forming apparatus 200. The extension application library 330 is a desired group of applications that are individually installed and run in order to extend the functions implemented by the image forming apparatus 200. Each application displays a screen in the operation unit 261, and implements various types of functions in response to user operations accepted by the operation unit 261.

FIG. 4 illustrates an example in which copying 321 and application management 322 are included in the basic application library 320. Copying 321 is an application for executing a copy job of scanning a document and printing onto a sheet. Application management 322 is an application for managing the installation and uninstallation of extension applications in the extension application library 330.

FIG. 4 illustrates, as an example, a state in which extension applications of user login authentication 331, cloud scanning 332, and cloud print 333 are installed as the extension application library 330. User login authentication 331 is an application that displays a screen for entering user credentials in the operation unit 261 and implements user login processing for the image forming apparatus 200 using the user credentials entered from the operation unit 261. User login processing is implemented not only using the user credentials entered through the operation unit 261, but also using user credentials read through an ID card reader or a biometric authentication device connected through the expansion device I/F. User login authentication 331 communicates with the cloud print service 100 over the network I/F 270. User login authentication 331 then authenticates the user by verifying user credentials managed in the cloud print service 100 against the user credentials entered in the image forming apparatus 200. User login authentication 331 may also authenticate the user by verifying the user credentials against user credentials managed by user management 351.

Cloud scanning 332 is an application that communicates with an unspecified cloud storage service 110 and transmits, to the cloud storage service 110, an image file read by executing a scanning job in the image forming apparatus 200. Cloud print 333 is an application that communicates with the cloud print service 100, obtains image data to be printed from the cloud print service 100, and executes a print job in the image forming apparatus 200. Cloud print 333 is an application that obtains file data to be printed from the cloud storage service 110 and executes a print job in the image forming apparatus. Cloud print 333 also transmits a result of executing the print job to the cloud print service 100.

### Software Configuration of Cloud Server

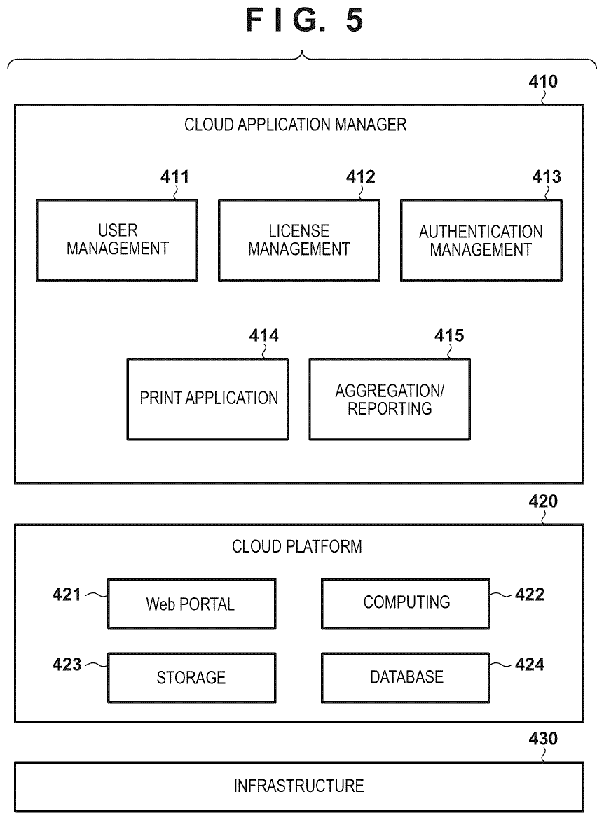

The software configuration of the cloud print service 100 will be described next with reference to FIG. 5. Infrastructure 430 is the foundation upon which the cloud server provides various services, and is configured including a server, a virtual machine, cloud storage, a network, and an operating system.

A cloud platform 420 is a framework that utilizes the infrastructure 430 to provide common basic functions to a cloud application manager 410. In other words, the cloud platform 420 is configured including a web portal 421, computing 422, cloud storage 423, and a database 424.

The cloud application manager 410 is a group of various applications that run on the cloud platform 420. The cloud application manager 410 is configured including user management 411, license management 412, authentication management 413, a print application 414, and aggregation/reporting 415.

User management 411 centrally manages user information on the cloud print service 100. Users are registered and deleted through an operation panel of the image forming apparatus 200. User management 411 manages the user information using the database 424. User management 411 is also a web application that provides an API for accepting user authentication instructions from user login authentication 331, which runs

### On the Image Forming Apparatus 200.

License management 412 is a web application that provides a web service screen for centrally managing the applications on the cloud print service 100 using the web portal 421. Through this web service screen, the user can install and uninstall applications to be managed, as well as register licenses for the applications. License management 412 is also a web application that provides an API for accepting license registration instructions from user login authentication 331 and application management 322, which run on the image forming apparatus 200. There are cases where license registration instructed by application management 322 of the image forming apparatus 200 is successful. In such a case, license management 412 obtains an application that uses the cloud print service 100 and that runs on the image forming apparatus 200 from the cloud storage 423 and provides the application to the image forming apparatus 200.

Authentication management 413 is a web application that provides a web service screen for setting the user login authentication method using the web portal 421. This web service screen makes it possible to set the user login authentication method for each application centrally managed on the cloud print service 100. Authentication management 413 manages the user login authentication method using the cloud storage 423 or the database 424. Authentication management 413 is also a web application that provides an API for accepting setting information obtainment instructions from user login authentication 331, which runs on the image forming apparatus 200. Authentication management 413 is also responsible for accessing various web service screens provided by the cloud application manager 410, and user authentication during API calls.

User management 411, license management 412, and authentication management 413, which are run on the cloud print service 100, and user login authentication 331, which is run on the image forming apparatus 200, are capable of running in tandem. By running in tandem in this manner, it is possible to log in to a device linked to the cloud print service 100 using the centrally-managed user authentication method and credentials.

The print application 414 is a web application that provides an API for accepting an instruction to obtain a document to be printed, and an instruction to execute the printing, from cloud print 333, which is executed on the image forming apparatus 200, using the web portal 421. The print application 414 accepts the instruction to obtain the document to be printed and returns a list of documents to be printed that are present in the cloud storage. The print application 414 also accepts a print execution instruction and converts the print execution instruction into a data format that can be printed by the image forming apparatus 200 using computing 422. The print application 414 is also a web application that provides an API for accepting print jobs transmitted by email from the information processing equipment 51, and an API for accepting print job obtainment instructions from cloud print 333. The print application 414 on the cloud server, and cloud print 333 is executed on the image forming apparatus 200, are capable of running in tandem. By running in tandem, the user can execute the same print workflow in devices linked to the cloud print service 100.

Aggregation/reporting 415 is a web application that provides an API for accepting job execution results transmitted from cloud scanning 332 and cloud print 333, which are executed on the image forming apparatus 200, using the web portal 421. Aggregation/reporting 415 is also a web application that perform processing for aggregating the received job execution results and providing a web service screen that displays the aggregation results using computing 422.

Note that the various web service screens and APIs provided by the cloud application manager 410 are managed individually on a tenant-by-tenant basis. For example, a different URL is generated for each tenant. The various types of data managed by the cloud application manager 410 are also managed individually on a tenant-by-tenant basis.

### Software Configuration of Information Processing Equipment

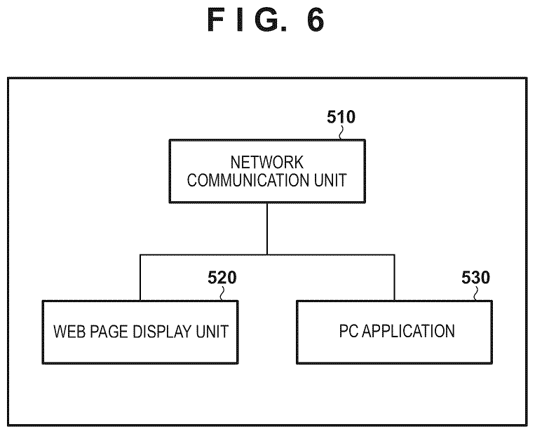

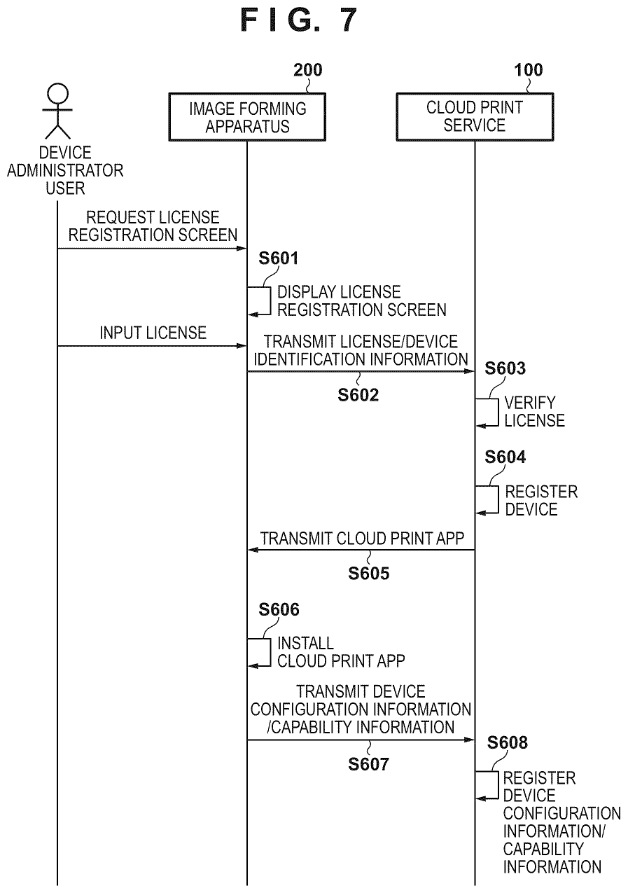

The software configuration of the information processing equipment 51 will be described next with reference to FIG. 6. A program running on the information processing equipment 51 is configured including a network communication unit 510, a web page display unit 520, and a PC application 530. The network communication unit 510 is a module for data communication with the cloud print service 100 connected over a network (10 or 20). The web page display unit 520 is a web browser that displays various web service screens provided by the cloud print service 100 and accepts user operations through those screens. The PC application 530 displays screens and accepts operations made in the screens. The PC application 530 generates print data in accordance with instructions from an end user, and transmits the print data (also called “submitted data” hereinafter) to the cloud print service 100 through the network communication unit 510.

### Processing Example 1

The flow of a sequence through which the image forming apparatus 200 is registered with the cloud print service 100 and an application for using the cloud print service 100 is installed in the image forming apparatus 200 will be described next with reference to FIG. 7. This sequence is realized by the image forming apparatus 200 and the cloud print service 100 executing processing for each other while communicating over the network 10. The processing by the image forming apparatus 200 is realized by programs stored in the ROM 240 being read out into the RAM 230 and executed by the CPU 220. Similarly, the processing by the cloud print service 100 is realized by programs stored in the ROM 140 being read out into the RAM 130 and executed by the CPU 120. This sequence is executed upon an instruction for execution being made by a device administrator of the image forming apparatus 200 through the operation unit 261.

In step S601, application management 322 of the image forming apparatus 200 receives, from the device administrator, an instruction requesting a registration screen for a usage license of the cloud print service 100, and displays a license registration screen in the operation unit 261.

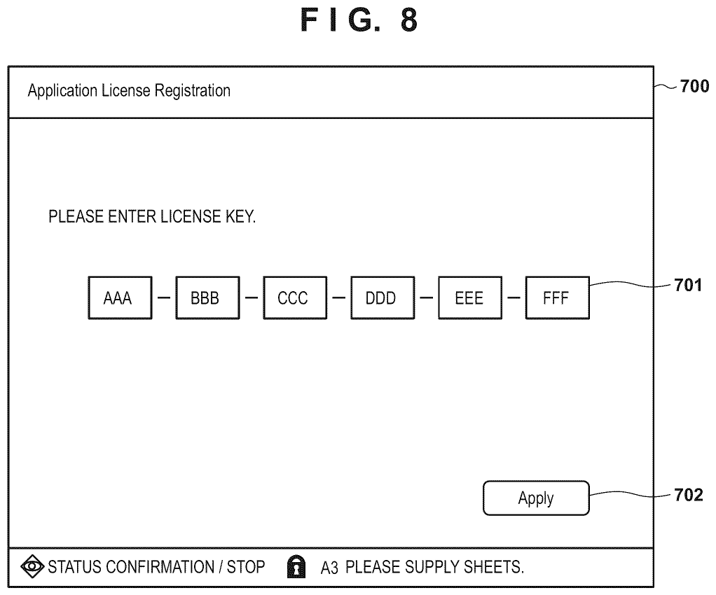

The license registration screen displayed in the operation unit 261 in step S601 will be described with reference to FIG. 8. The device administrator enters a license key for extending the functions of the image forming apparatus 200, which the device administrator has already obtained, into a license key entry field 701 through the operation unit 261. The device administrator can then apply the corresponding license to the image forming apparatus 200 by touching an “apply” icon 702. It is assumed here that the device administrator has entered the usage license key of the cloud print service 100 in the license registration screen displayed in step S601.

In step S602, along with the entered license key, application management 322 transmits a serial number, as information capable of identifying the individual image forming apparatus 200, to the cloud print service 100 through the network I/F 270. In step S603, the cloud print service 100 receives the license key and the serial number from step S602 through the network I/F 170, and license management 412 verifies the license key. If license management 412 determines that the license key is a valid license key for the cloud print service 100, the sequence moves to step S604.

In step S604, license management 412 registers the image forming apparatus 200 having the serial number received in step S603 in the database 424 as a device with which the cloud print service 100 can be used. Note that when the same administrator executes the processing from steps S601 to S604 for a plurality of image forming apparatuses 200, the plurality of image forming apparatuses 200 are set to belong to the same tenant (an example of “first information”).

In step S605, license management 412 transmits an application for using the cloud print service 100 to the image forming apparatus 200 through the network I/F 170. In step S606, application management 322 of the image forming apparatus 200 installs the received application for using the cloud print service in the image forming apparatus 200. Through this processing, cloud print 333 in FIG. 4 can be used in the image forming apparatus 200.

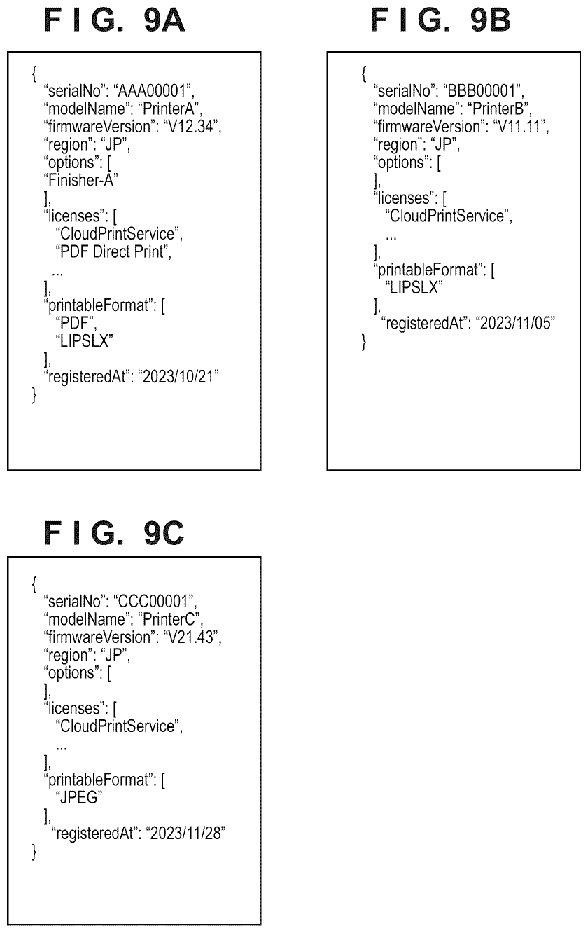

In step S607, cloud print 333 obtains the configuration information and capability information of the image forming apparatus 200 from the data management module 353, and transmits the information to the cloud print service 100 through the network I/F 270. FIGS. 9A to 9C illustrate the configuration information and capability information of the image forming apparatus 200 transmitted by cloud print 333 in step S607. In the examples in FIGS. 9A to 9C, “serialNo” indicates the serial number, “modelName” indicates the model, and “firmwareVersion” indicates the firmware version. “Region” indicates the country for use, “licenses” indicates a list of registered licenses, “printableFormat” indicates the data formats that can be printed, and “registeredAt” indicates a registration date/time. The registered licenses include licenses for services such as cloud print services and direct printing. The configuration information and capability information also include information on optional equipment, such as a finisher, as “options”.

In step S608, the print application 414 of the cloud print service 100 receives the configuration information and capability information of the image forming apparatus 200 through the network I/F 170. The print application 414 then searches the registered serial numbers for a number that matches the serial number contained in the received configuration information and capability information. The received configuration information and capability information are then registered in the database 424 in association with the matching serial number. The sequence then ends. Executing the sequence as described above results in the image forming apparatus 200 being registered with the cloud print service 100 as a device capable of using the cloud print service 100.

### Processing Example 2

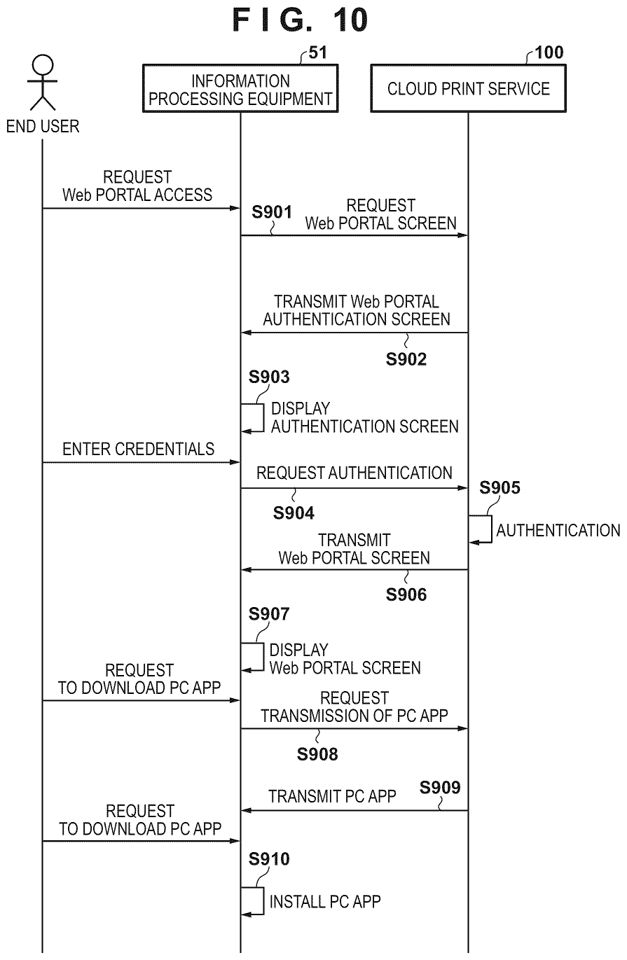

The flow of a sequence for displaying various web portal screens in the information processing equipment 51, and installing a PC app for using the cloud print service 100 in the information processing equipment 51, will be described with reference to FIG. 10. This sequence is realized by the information processing equipment 51 and the cloud print service 100 executing processing for each other while communicating over the network 10. The processing by the information processing equipment 51 is realized by programs stored in the ROM 514 being read out into the RAM 513 and executed by the CPU 512. Similarly, the processing by the cloud print service 100 is realized by programs stored in the ROM 140 being read out into the RAM 130 and executed by the CPU 120. Note that this sequence is executed when an end user of the cloud print service 100 launches the web page display unit 520, such as a web browser of the information processing equipment 51.

In step S901, the web page display unit 520 receives, from the end user, an access request for access to the web portal 421 of the cloud print service 100. The web page display unit 520 then requests the screen of the web portal 421 from the cloud print service 100 through the network communication unit 510.

In step S902, the web portal 421 of the cloud print service 100 accepts the request for the screen of the web portal 421. The web portal 421 then transmits an authentication screen for logging into the web portal 421 to the information processing equipment 51 through the network I/F 170.

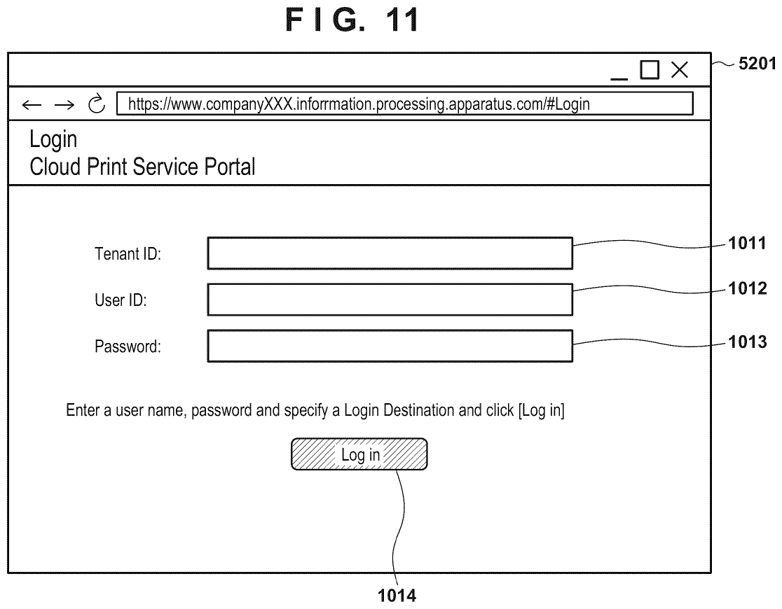

In step S903, the network communication unit 510 of the information processing equipment 51 receives the authentication screen. The web page display unit 520 then displays the authentication screen in the operation unit 516. This authentication screen will be described with reference to FIG. 11. Tenant ID, user ID, and password entry fields 1011 to 1013, which are for entering information necessary for authentication of the cloud print service 100, are arranged on a web page 5201 displayed on the web browser of the information processing equipment 51. A button 1014 for confirming the entries in the entry fields 1011 to 1013 is also provided in the web page 5201. The end user enters credentials for logging into the cloud print service 100 in the entry fields 1011 to 1013, and touches the button 1014. The web page display unit 520 then detects the button 1014 being touched.

In step S904, the web page display unit 520 transmits the authentication request, along with the credentials entered by the end user, to the cloud print service 100. In step S905, the web portal 421 of the cloud print service 100 receives the authentication request. The web portal 421 then inputs the received credentials to authentication management 413, and authentication management 413 then verifies the credentials. It is assumed here that the verification of the credentials indicates that the credentials are correct information.

In step S906, the web portal 421 transmits the screen of the web portal 421 to the information processing equipment 51. The network communication unit 510 of the information processing equipment 51 receives the screen of the web portal 421. In step S907, the web page display unit 520 displays the screen of the web portal 421 in the operation unit 516.

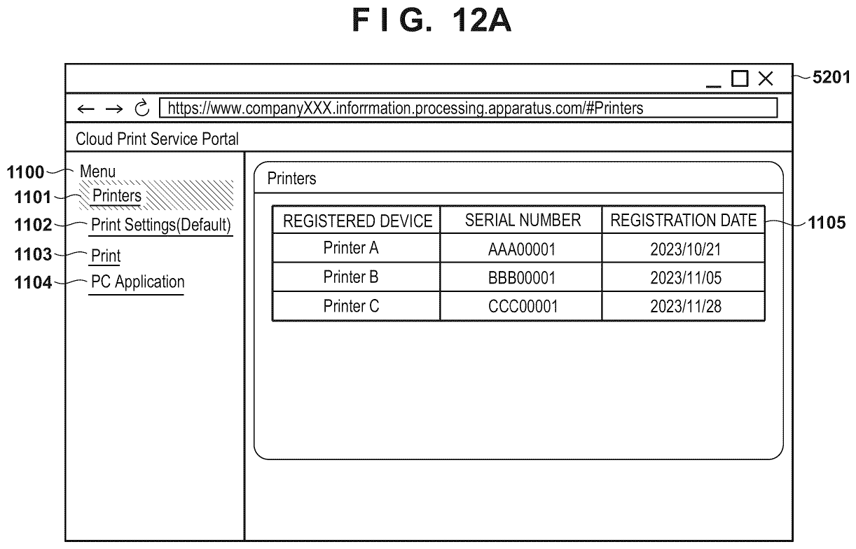

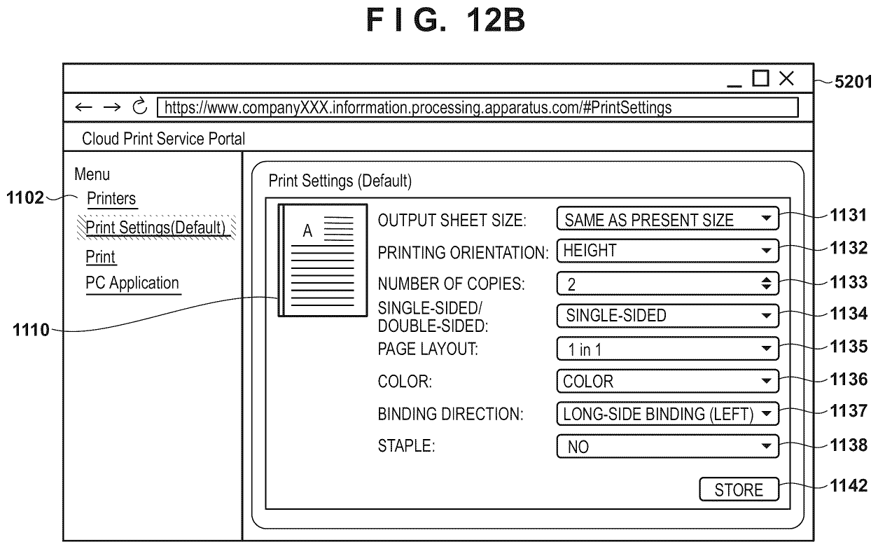

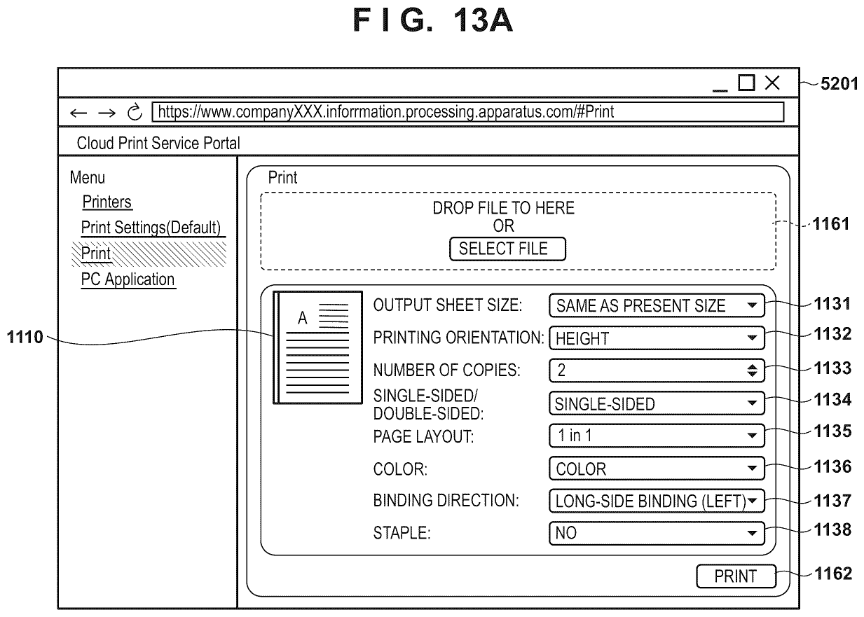

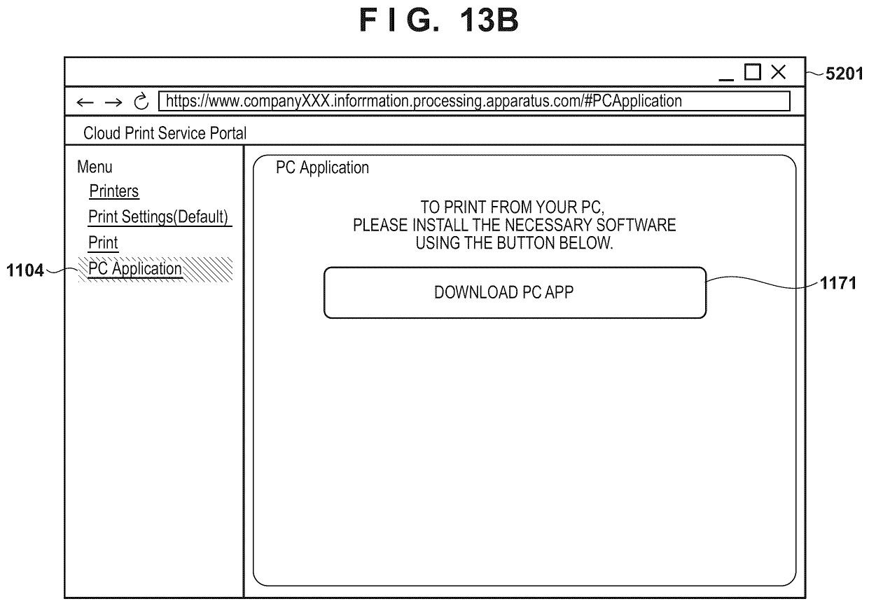

The screen of the web portal 421 displayed by the web page display unit 520 on the web page 5201 will be described with reference to FIGS. 12A, 12B, 13A, and 13B. A menu 1100 is displayed on the left side of the screen of the web portal 421. A registered printer list menu 1101, a print settings menu 1102, a print instruction menu 1103, and a settings menu 1104 for the PC application 530 are displayed as sub-menus constituting the menu 1100.

More specifically, FIG. 12A illustrates the screen of the web portal 421 displayed when the end user selects the registered printer list menu 1101. A registered printer list 1105 indicating a list of the image forming apparatuses 200 registered with the tenant to which the end user of the cloud print service 100 authenticated in step S905 belongs is displayed in this screen. A model name (registered device), serial number, and registration date of the registered printer are displayed in the registered printer list 1105. Note that these display items are merely examples, and other items, e.g., the configuration information or capability information of each registered printer, may be displayed as well.

FIG. 12B illustrates the screen of the web portal 421 displayed when the end user selects the print settings menu 1102. A default print settings list is displayed in this screen. These settings are applied when the end user of the cloud print service 100 authenticated in step S905 executes printing through a sequence that will be described later. Note that the displayed print settings screen is merely an example, and is displayed in a pull-down menu in which the settings for the output sheet size, printing orientation, number of copies, single-sided/double-sided, page layout, color mode, binding direction, stapling, and the like are set as indicated by 1131 to 1138. A print settings field 1110 illustrating the settings and a button 1142 for applying the settings are displayed in the same screen.

FIG. 13A illustrates the screen of the web portal 421 displayed when the end user selects the print instruction menu 1103. This screen is a screen for the end user of the cloud print service 100 authenticated in step S905 to submit data to be printed. The screen includes a data submission field 1161, print settings fields 1110 and 1131 to 1138, and a print instruction button 1162. The data submission field 1161 is a field for the end user to drag and drop a file to be printed into the field on the screen, or to submit a file to be printed by a file selection method provided by the OS of the information processing equipment 51. The print settings field 1110 is the same field as that used when displaying the default print settings displayed when the aforementioned print settings menu 1102 is selected. Here, the default print settings set in the print settings menu 1102 are displayed. The end user can also make changes to the displayed settings. The print instruction button 1162 is a button that, when touched, executes a print instruction in accordance with the details set in the data submission field 1161 and the print setting fields 1110 and 1131 to 1138. Note that the sequence of processing performed when the print instruction is executed will be described in detail later.

FIG. 13B illustrates the screen of the web portal 421 displayed when the settings menu 1104 of the PC application 530 has been selected. A download button 1171 for downloading the PC application 530 of the cloud print service 100 is displayed in this screen. The end user of the cloud print service 100 authenticated in step S905 can download and install the PC application 530 by touching the download button 1171. Such processing makes it possible for the end user to submit a desired file as a file to be printed from software installed in the PC, such as word processing software, spreadsheet software, presentation software, or the like. The sequence for installing the PC application 530 and the sequence for instructing printing will be described later.

The descriptions will now return to FIG. 10. In step S908, the web page display unit 520 accepts a touch operation on the screen of the web portal 421. Here, the web page display unit 520 accepts an input for selecting the settings menu 1104 of the PC application 530 shown in FIG. 12A. The web page display unit 520 then displays the screen illustrated in FIG. 13B, and accepts a touch operation on the download button 1171 of the PC application 530. The web page display unit 520 then transmits, to the cloud print service 100, a download request for downloading the PC application 530.

In step S909, the web portal 421 of the cloud print service 100 receives the download request of the PC application 530, obtains the PC application 530 held in cloud storage 423, and transmits the download request to the information processing equipment 51. Note that the format of the PC application 530 to be transmitted is executable file format, or a format in which an executable file is compressed, e.g., ZIP format, and is a format that enables installation by the end user using the OS function of the information processing equipment 51.

In step S910, the network communication unit 510 of the information processing equipment 51 receives the PC application 530. The information processing equipment 51 then installs the PC application 530 in response to an instruction from the end user, e.g., an instruction for executing an executable file. The sequence then ends. The foregoing sequence makes it possible for the end user of the cloud print service 100 to install and use the PC application 530 for using the service on the information processing equipment 51.

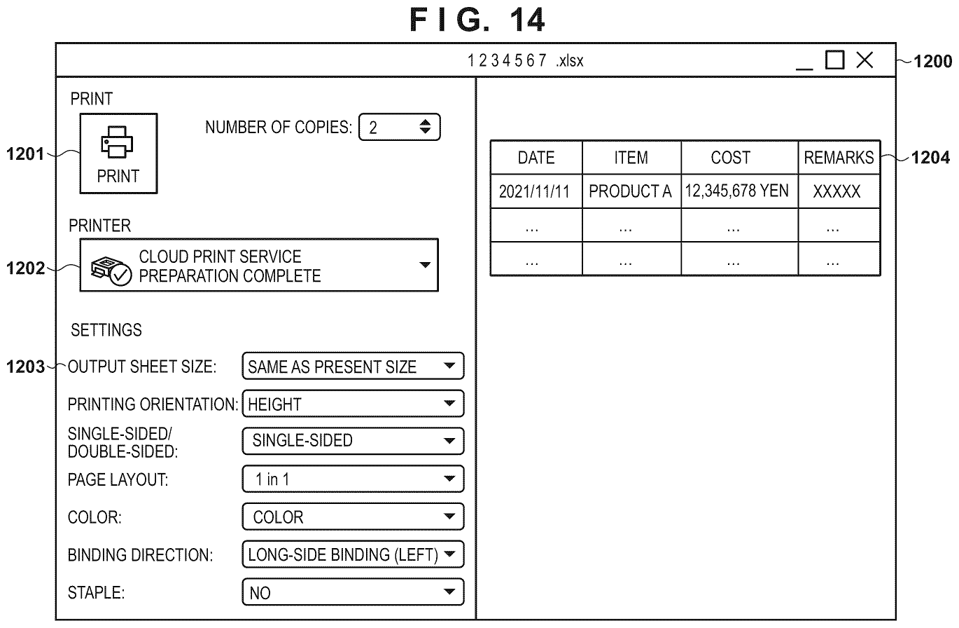

A screen for using the PC application 530 installed in the information processing equipment 51 will be described next with reference to FIG. 14. Through this screen, the end user can instruct the cloud print service 100 to print a file opened using spreadsheet software installed in the information processing equipment 51.

More specifically, the end user has opened a file called “1234567.xlsx” in the spreadsheet software, and has opened the print instruction screen in a window 1200. A print instruction button 1201, a printer selection pull-down display 1202, a print settings menu 1203, and a print preview display 1204 are displayed in the window 1200. Once the PC application 530 of the cloud print service 100 is installed by executing the sequence described earlier with reference to FIG. 10, “cloud print service” becomes selectable in the printer selection pull-down display 1202. When the end user selects “cloud print service” and touches the print instruction button 1201, the PC application 530 generates print data in which the file which is currently open is printed with the setting values set in the print settings menu 1203. The network communication unit 510 then transmits (submits) the print data to the cloud print service 100.

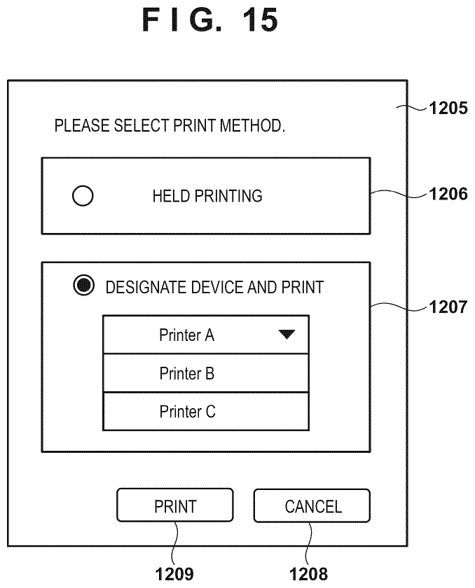

A screen of the PC application 530 launched in the information processing equipment 51 when print data is submitted to the cloud print service 100 (an example of a “setting screen”) will be described next with reference to FIG. 15. Note that at launch, an authentication flow equivalent to the authentication described with reference to FIG. 11 is performed, and the information processing equipment 51 transmits information about the end user (an example of “user information”) to the cloud print service 100. The information processing equipment 51 then obtains a list of devices included in the tenant to which the end user belongs. The PC application 530 then displays a device selection window 1205 based on the obtained device list information. The device selection window 1205 displayed here includes a button that enables held printing 1206, in which an image forming job can be saved temporarily in the cloud print service 100, to be selected. The device selection window 1205 also includes a device designation button 1207 through which printing can be executed immediately by designating a device, a print button 1209, and a cancel button 1208 that cancels the submission.

If the end user selects held printing 1206 and touches the print button 1209, the print job can be executed on any desired device. The “desired device” is one of the registered devices set to belong to the same tenant, displayed in the registered printer list 1105 illustrated in FIG. 12A (an example of the “first information”). On the other hand, if the end user wishes to select the device to use for printing, they select any desired device from a pull-down menu displayed from the device designation button 1207, through which printing can be executed having designated a device. The end user then touches the print button 1209. Here, the displayed list of devices (an example of “first identification information”) matches the registered devices associated with the tenant to which the end user belongs, displayed in the registered printer list 1105 illustrated in FIG. 12A. Note that the device designation button 1207 is not limited to the pull-down format, and may be any display enabling a device to be selected. The PC application 530 also includes information on the print type (whether the printing is held printing), as well as the device information if the device for printing is designated, in the print data.

### Processing Example 3

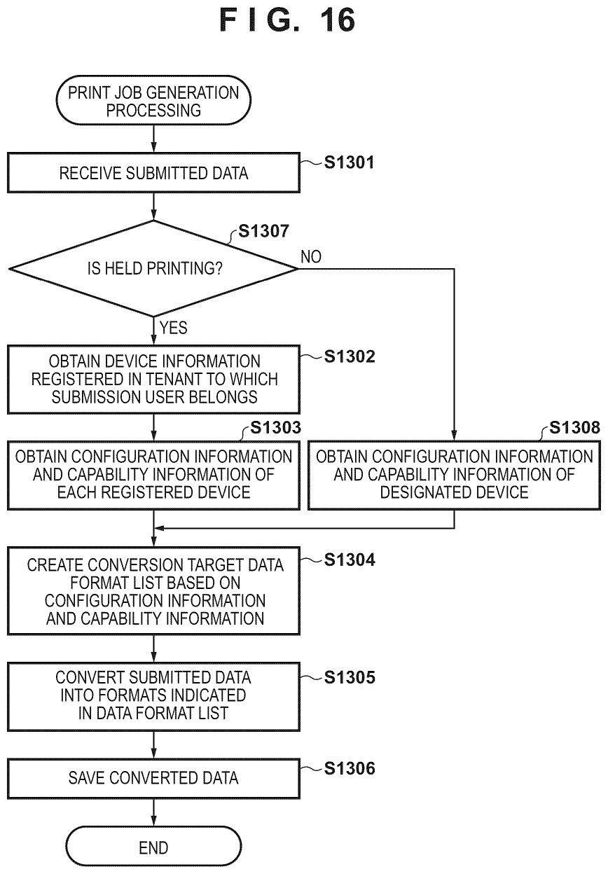

Processing through which the cloud print service 100 generates a print job on the basis of data submitted from the information processing equipment 51 and saves the print job in association with data converted into a printable format will be described next with reference to FIG. 16. Note that this processing is realized by programs stored in the ROM 140 being read out into the RAM 130 and executed by the CPU 120. This processing is executed when the end user of the cloud print service 100 submits data to the cloud print service 100 by operating the screen illustrated in FIG. 15, for example.

In step S1301, the print application 414 receives submitted data transmitted from the information processing equipment 51 through the network I/F 170 in response to the print button 1209 (FIG. 15) having been touched.

In step S1307, the print application 414 determines whether the print type of the submitted data received in step S1301 is held printing. The sequence moves to step S1302 if the print application 414 determines the type is held printing, and to step S1308 if not.

In step S1302, the print application 414 obtains a list of printers registered in the tenant to which the end user belongs from the database 424. Note that the list of printers obtained matches the printers displayed in the pull-down display 1202 in the registered printer list screen illustrated in FIG. 14.

In step S1303, the print application 414 obtains the configuration information and capability information of each registered printer registered in the database 424 in step S608 from the information on the registered printers obtained in step S1302. Note that the formats of the configuration information and the capability information are, for example, the formats illustrated in FIGS. 9A to 9C for each registered printer.

In step S1308, the print application 414 obtains the configuration information and capability information of the designated device included in the submitted data received in step S1301. Note that the formats of the configuration information and the capability information are, for example, the formats illustrated in FIGS. 9A to 9C for each printer.

In step S1304, the print application 414 creates a conversion format list indicating conversion formats in order to convert the submitted data received in step S1301 into a format that can be printed by each device. The conversion format list is created by obtaining the values of “printableFormat” from the configuration information and capability information of each of the devices obtained in S1303 or S1308 and taking the sum of the sets. More specifically, for example, in step S1303, the configuration information and capability information for each device may be obtained with the content illustrated in FIGS. 9A to 9C. In such a case, the values of “printableFormat” for the devices are “PDF, LIPSLX”, “LIPSLX,” and “JPEG”, respectively. Accordingly, the sum of the sets, i.e., “PDF, LIPSLX, JPEG”, is created as the conversion format list.

In step S1305, the print application 414 converts the submitted data received in step S1301 into each format indicated in the conversion format list generated in step S1304 to generate printable format data. Note that the print application 414 is an example of a “data conversion unit”. The submitted data is an example of “first data”. The printable format data is an example of “second data capable of forming an image in an image forming apparatus”.

In step S1306, the print application 414 saves the printable format data converted in step S1305 in cloud storage 423 (an example of a “storage unit capable of storing the second data”). Note that when the print type is held printing, the print application 414 stores information that can identify the end user who submitted the data (a user ID or the like) in association with the printable format data as a held print job. However, when the print type is not held printing, the print application 414 stores information that can identify the end user who submitted the data (a user ID or the like) and the designated device information in association with the printable format data as a device-designated print job. The print application 414 then transmits the device-designated print job to the image forming apparatus 200, and printing is executed by the image forming apparatus 200 to which the job has been transmitted. The print application 414 then ends the sequence illustrated in this flowchart.

### Processing Example 4

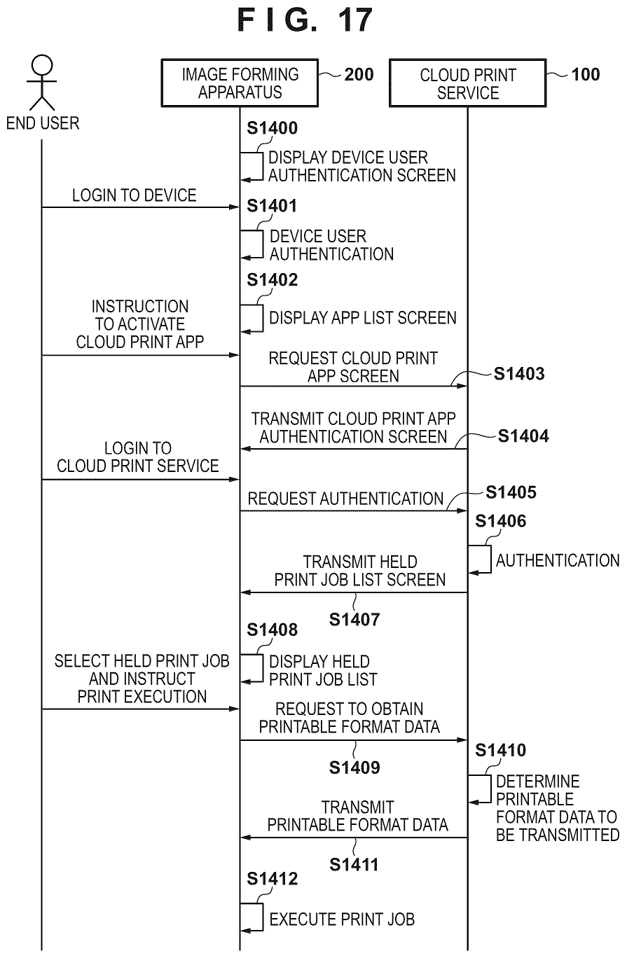

The flow of a sequence of processing by which the image forming apparatus 200 prints the printable format data stored in the cloud print service 100 by executing the sequence illustrated in FIG. 16 will be described next with reference to FIG. 17. This sequence is realized by the image forming apparatus 200 and the cloud print service 100 executing processing for each other while communicating over the network 10. The processing by the image forming apparatus 200 is realized by programs stored in the ROM 240 being read out into the RAM 230 and executed by the CPU 220. Similarly, the processing by the cloud print service 100 is realized by programs stored in the ROM 140 being read out into the RAM 130 and executed by the CPU 120. Note that the processing illustrated in this sequence is started when the operation unit 261 of the image forming apparatus 200 is activated by being touched or the like by the end user of the image forming apparatus 200 and the cloud print service 100.

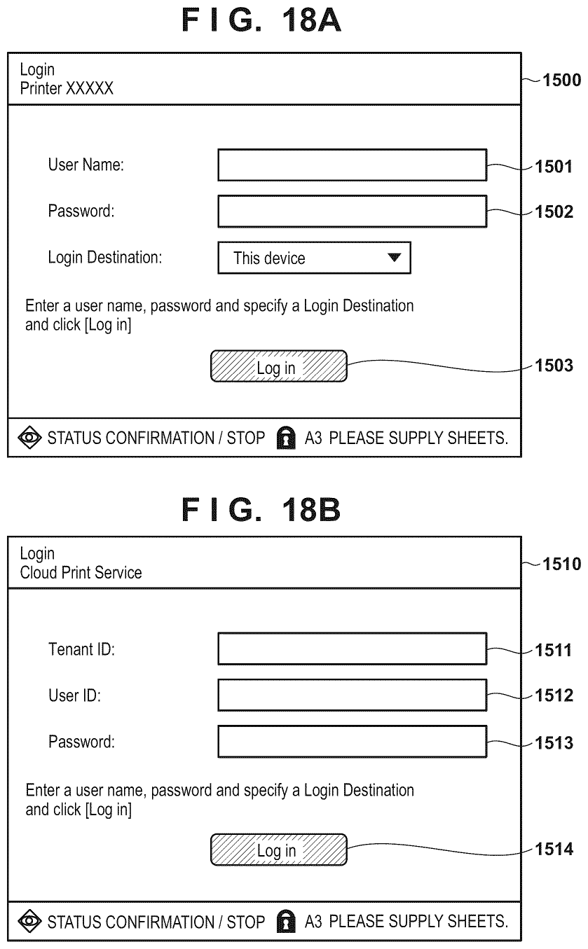

In step S1400, the application platform 340 of the image forming apparatus 200 displays a login screen for logging in to the image forming apparatus 200 in the operation unit 261. The login screen for logging in to the image forming apparatus 200, displayed in step S1400, will be described next with reference to FIG. 18A. A user ID entry field 1501 and a password entry field 1502 are disposed in the screen. The user enters the user ID and password of a user registered in the image forming apparatus 200 using the operation unit 261, and touches a “log in” button 1503. Upon doing so, the application platform 340 accepts the touch operation, and can execute the login instruction.

In step S1401, the application platform 340 verifies the user credentials registered in the user management 351 against the user ID and password entered by the end user when the login instruction was made, and performs authentication. In step S1402, if the authentication in step S1401 has succeeded, the application platform 340 displays an application list screen indicating applications installed in the image forming apparatus 200.

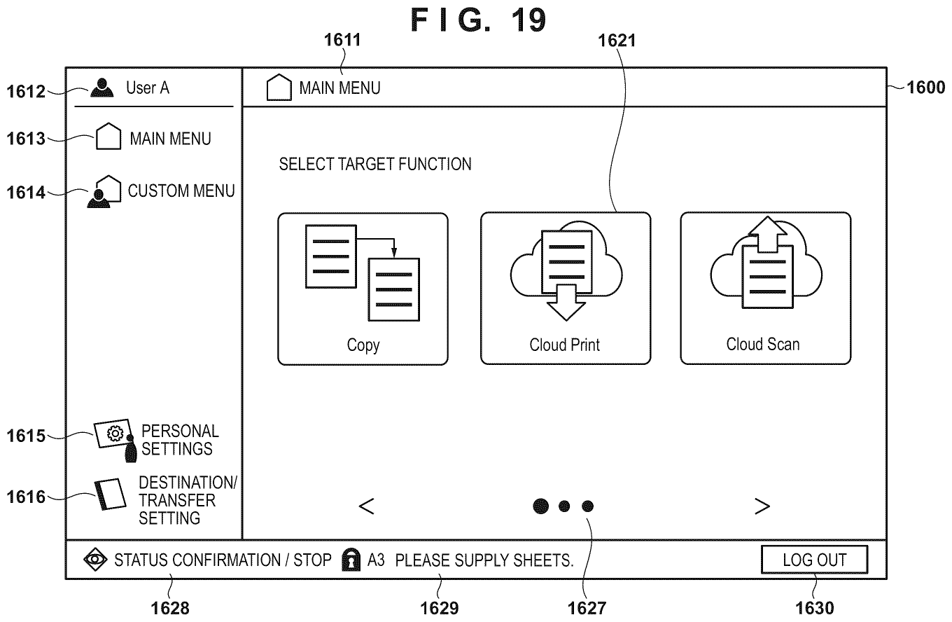

The application list screen of the image forming apparatus 200, displayed in step S1402, will be described next with reference to FIG. 19. An operation panel screen 1600 is configured including, for example, a window title 1611, a username display field 1612, a main menu icon 1613, a custom menu icon 1614, a personal settings icon 1615, and a destination/transfer settings icon 1616. Icons such as a “Copy” icon, a “Cloud Print” icon 1621, and a “Cloud Scan” icon are furthermore displayed in the screen as function icons. These function icons are displayed or hidden depending on the license. The screen is further configured including a “status confirmation/stop” display button 1628 for displaying the status of the image forming apparatus 200, an “error status display field”1629, and a “log out” button 1630 for logging out the user who is currently logged in. Note that the icon corresponding to the print application installed in the image forming apparatus 200 in step S606 of FIG. 7 is “Cloud Print”1621.

The descriptions will return to the sequence illustrated in FIG. 17. In step S1403, the application platform 340 launches cloud print 333 in response to the end user touching the icon of “Cloud Print” 1621 in the operation panel screen 1600. The launched cloud print 333 then requests the screen of the cloud print app from the cloud print service 100.

The print application 414 of the cloud print service 100 requested in step S1404 transmits an authentication screen for logging into the cloud print service 100 to the image forming apparatus 200 through the network I/F 170. FIG. 18B illustrates an example of this authentication screen. Fields 1511, 1512, and 1513 for entering login information (also referred to as credentials), such as the ID of the tenant to which the end user of the cloud print service 100 belongs, the user ID, and the password, are arranged in the authentication screen. A login instruction button 1514 is also provided in the authentication screen.

In step S1405, the end user enters the login information in the fields 1511 to 1513 of the authentication screen illustrated in FIG. 18B, and touches the login instruction button 1514. In response to this operation, cloud print 333 transmits the authentication request along with the credentials to the cloud print service 100.

In step S1406, the print application 414 of the cloud print service 100 transmits the received credentials to authentication management 413. Authentication management 413 then verifies the credentials. If the credentials are successfully verified, in step S1407, the print application 414 generates a held print job list screen indicating held print jobs submitted in advance by the authenticated user, and transmits the screen to the image forming apparatus 200. The list screen may be a list screen of held print jobs created through the sequence illustrated in FIG. 16 and saved in the cloud storage 423 on the basis of data submitted by the authenticated user.

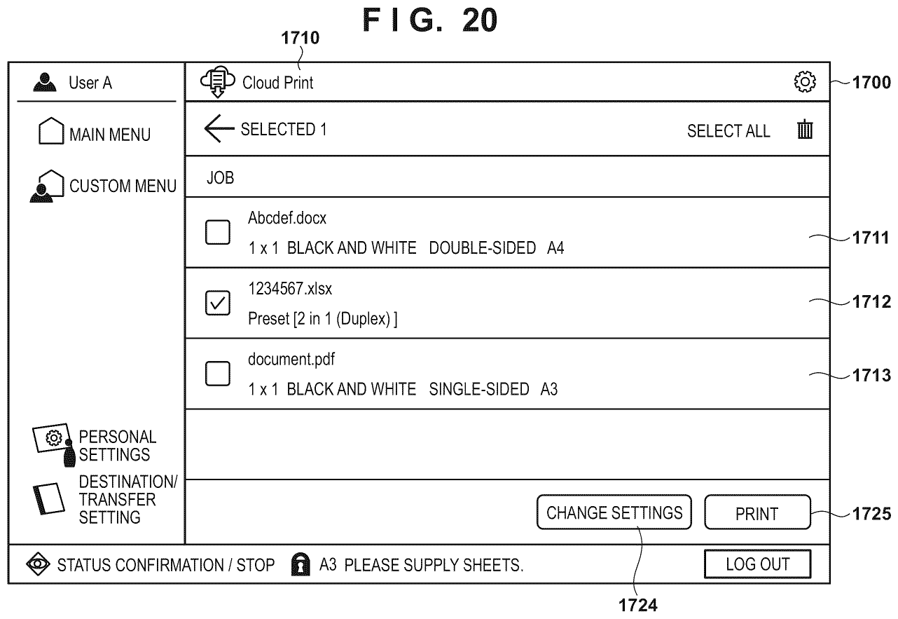

In step S1408, cloud print 333 of the image forming apparatus 200 displays, in the operation unit 261, the held print job list screen received in step S1407. The screen for displaying the list of held print jobs, displayed in the operation panel of the image forming apparatus 200, will be described next with reference to FIG. 20. A held print job list display screen 1700 is configured including a list of held print jobs 1711 to 1713, a setting change button 1724, and a print button 1725. Of the held print jobs saved through the flow illustrated in FIG. 16, a list of the held print jobs submitted by the end user authenticated in step S1406 is displayed in the held print job list. The end user can select a job to be printed from the list of held print jobs through the operation unit 261, and instruct the printing to be executed by touching the print button 1725. FIG. 20 illustrates a screen in which a held print job 1712 corresponding to the filename “1234567.xlsx” in the submitted data is selected. Note that in the sequence that follows thereafter, it is assumed that the print button 1725 has been touched by the end user in this state.

In step S1409, cloud print 333 requests the cloud print service 100 to obtain print data, corresponding to the held print job instructed to be printed by the end user, in a format that can be printed by the image forming apparatus 200. When this obtainment request is made, cloud print 333 transmits information identifying the image forming apparatus 200 (e.g., a serial number) to the cloud print service 100. In other words, it is assumed that the printer to which the end user has input the print instruction is “Printer B” in the list of registered printers illustrated in FIG. 12A. The obtainment request is then transmitted to the cloud print service 100 in a form in which a serial number “BBB00001” is included.

The print application 414 of the cloud print service 100, which received the print data obtainment request in step S1410, determines the printable format data to be transmitted to the image forming apparatus 200 that made the request, using the details of the obtainment request. Specifically, the print application 414 identifies, in the database 424, the configuration information and capability information corresponding to the serial number of the image forming apparatus 200 that made the request, included in the print data obtainment request. In other words, the print application 414 identifies the configuration information and capability information (FIG. 9B) corresponding to the serial number “BBB00001”.

Next, the print application 414 identifies the printable format indicated by “Printableformat” using the identified configuration information and capability information. Then, of the data in each printable format stored in cloud storage 423 in step S1306, the print application 414 determines the data corresponding to the identified format as the printable format data to be transmitted to the image forming apparatus 200 that made the request. In other words, the print application 414 determines the data converted in the format “LIPSLX” for the submitted data of “1234567.xlsx” as the data that can be printed in the image forming apparatus 200.

In step S1411, the print application 414 transmits the printable format data determined in step S1410 to the image forming apparatus 200. Note that there are cases where a plurality of “Printableformats” for the image forming apparatus 200 from which the request was made are present, and a plurality of items of converted data in formats serving as candidates to be transmitted to the image forming apparatus 200 are present. In such cases, the print application 414 may transmit the converted data in the format highest in a priority order set in advance. Alternatively, the print application 414 may transmit all converted data serving as candidates to the image forming apparatus 200. The converted data on the basis of which printing is actually to be performed may be determined in accordance with a predetermined determination criteria in the image forming apparatus 200. Cloud print 333 of the image forming apparatus 200 then receives the printable format data. In step S1412, cloud print 333 instructs the job/device control module 352 to print the printable format data received in step S1411. Then, processing for printing the printable format data is executed.

### Actions and Effects

According to the image forming system 1 described above, image forming apparatuses 200 included in a tenant, which can be used by the end user, are selectably displayed in the screen of the PC application 530 as illustrated in FIG. 15. Accordingly, the usability is improved for the end user executing the printing.

### Variations

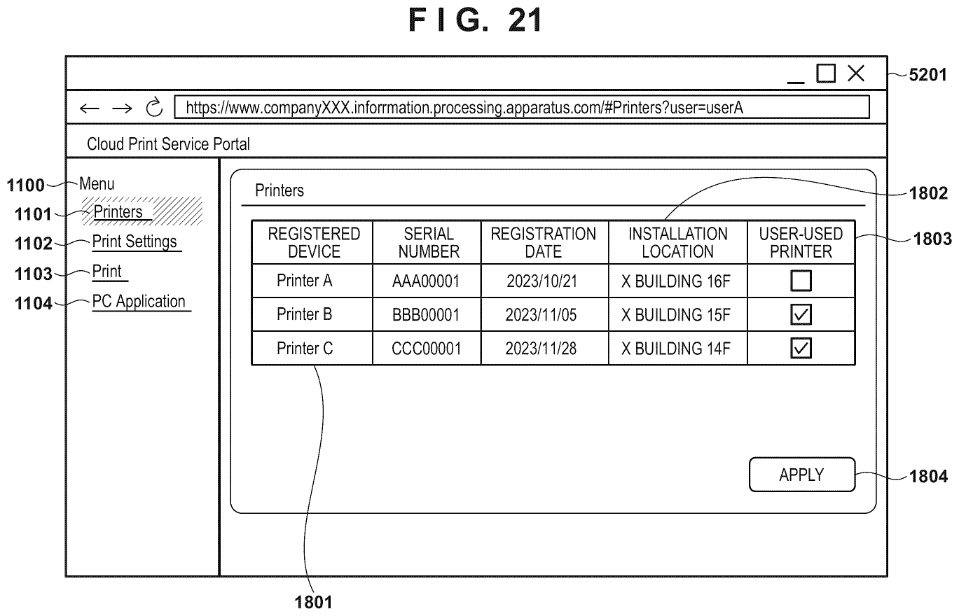

In the following, descriptions of parts where configurations and processing sequences are the same as in the foregoing embodiment will be omitted here, and only the differences will be described. Another example of the web portal 421 displayed when the registered printer list menu 1101 has been selected will be described with reference to FIG. 21. A registered device list 1801 according to a variation is displayed in association with an “installation location” 1802 and a “user-used printer” flag 1803, in addition to the screen content illustrated in FIG. 12A. The “user-used printer” flag 1803 is displayed such that the user authenticated in step S905 can specify whether to use each registered printer. In other words, a checkbox is provided for each of the registered printers, and the end user of the cloud print service 100 can place a checkmark for the printer that they will use for actual printing. The end user can then set the printer specified by the checkbox (an example of “second identification information”) as the printer to be used by the user for printing by touching an “apply” button 1804. Cloud print 333 then transmits this setting change information to the cloud print service 100. In the cloud print service 100, the print application 414 receives the setting change information and registers the information in the database 424.

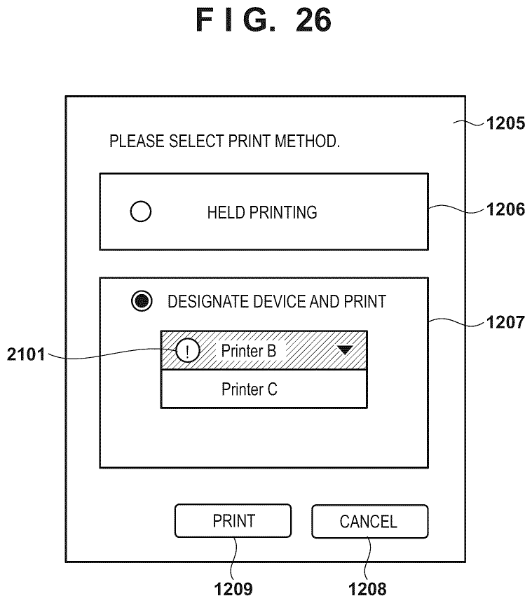

Additionally, if the authenticated user is determined in step S905 to be a user having administrator privileges (also called an “administrator” hereinafter), authentication management 413 may make it possible to change the tenant information settings. In other words, if a user having administrator privileges has placed a checkmark for the “user-used printer” flag 1803, the checked registered device may be made usable for an end user who also belongs to the tenant to which the administrator belongs. This end user is an example of a “specific user”. The checked registered device is an example of “second identification information”. The end user who also belongs to the tenant is an example of a “specific user”. Such setting changes are reflected in the device designation button 1207 illustrated in FIG. 26 (described later). Conversely, if the check box is unchecked, the “installation location” 1802 may similarly be displayed so as to be changeable by a user having administrator privileges making an input operation.

The administrator may also be made capable of setting the device designation button 1207 illustrated in FIG. 15 to be displayed in a non-selectable manner, and only held printing 1206 to be displayed in a selectable manner. In other words, in the screen illustrated in FIG. 15, the pull-down menu of the device designation button 1207 is not displayed or is grayed out such that the devices cannot be selected. Note that the form by which only held printing 1206 is displayed in a selectable manner is not limited to this form.

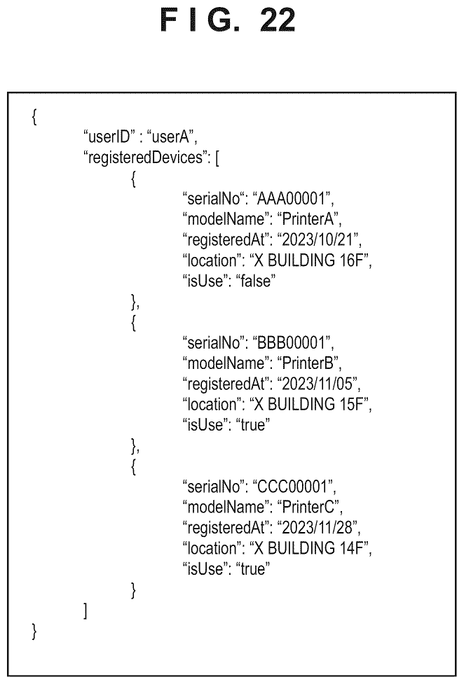

The data format in which the “installation location” 1802 and the “user-used printer” flag 1803 in FIG. 21 are held in the database 424 will be described with reference to FIG. 22. For each end user of the cloud print service 100, information of each registered printer is written as a “UserID” element, indicating an identifier of the user, and a “registeredDevices” element, indicating a list of registered printers. Furthermore, the “user-used printer” flag 1803 is written as an “isUse” value in the information of each registered printers. In addition, a value of “true” is set for a printer for which a checkmark is placed in FIG. 21, and a value of “false” is set for a printer for which no checkmark is placed. If the administrator user has entered installation location information, that entry is reflected in the “location”value.

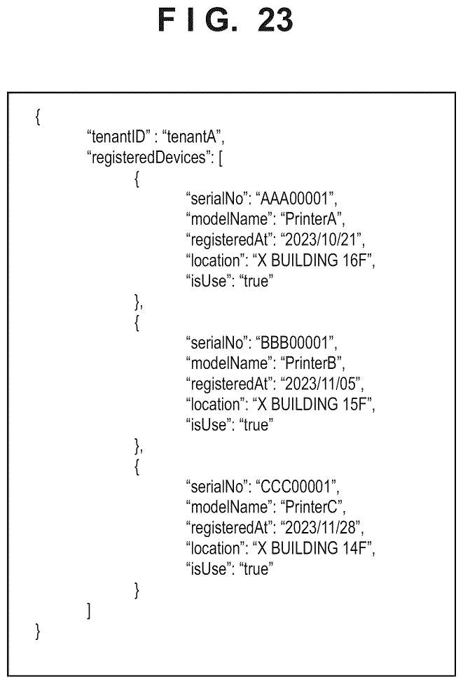

A data format in which the “installation location” 1802 and the “user-used printer” flag 1803 set by a user who is an administrator in the screen illustrated in FIG. 21 are reflected in the database 424 will be described next with reference to FIG. 23. “tenantID”, indicating an identifier of the tenant to which the end user belongs, is written for each end user of the cloud print service 100 who belongs to the same tenant as the administrator. Additionally, the information of each registered printer is written as a “registeredDevices” element, indicating a list of registered printers. Furthermore, the “user-used printer” flag 1803 is written as an “isUse” value in the information of each registered printers. In addition, a value of “true” is set for a printer for which a checkmark is placed in FIG. 21, and a value of “false” is set for a printer for which no checkmark is placed. Note that in the example in FIG. 23, “isUse” is set to “true” for “Printer B” and “Printer C” so as to correspond to the settings in the screen illustrated in FIG. 21.

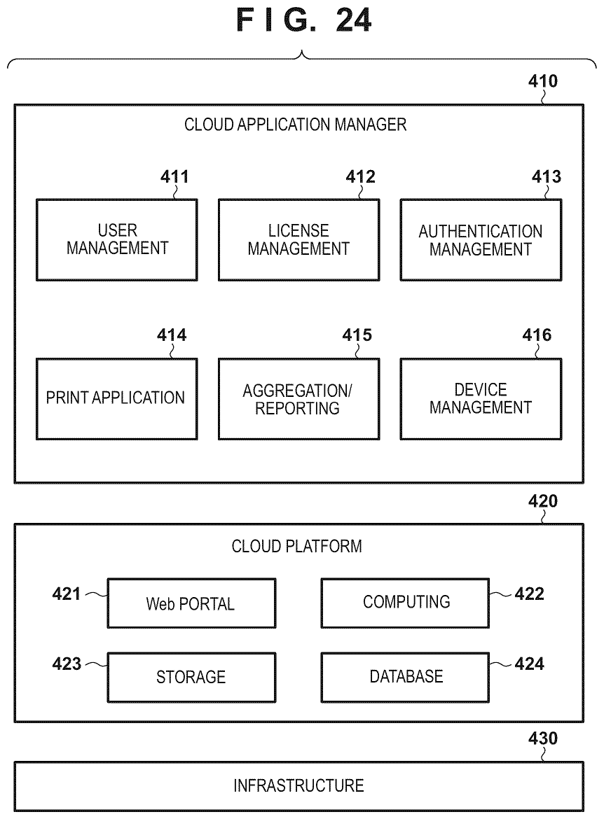

The software configuration of the cloud print service 100 according to the variation will be described next with reference to FIG. 24. In addition to the configuration described in the foregoing embodiment, the cloud application manager 410 according to the variation is configured including device management 416 that requests a device to transmit a signal regarding the status of the device (an example of “availability information”) and confirms the received signal. The status of the device is a status regarding, for example, whether the device is usable by a user, or whether the device is operating normally. Whether the device is usable is, for example, whether the device is online, whether the device is in a sleep state, or whether the device is powered on. Whether the device is operating normally is whether the device is out of sheets, whether the device is out of ink, whether the device has malfunctioned, or the like.

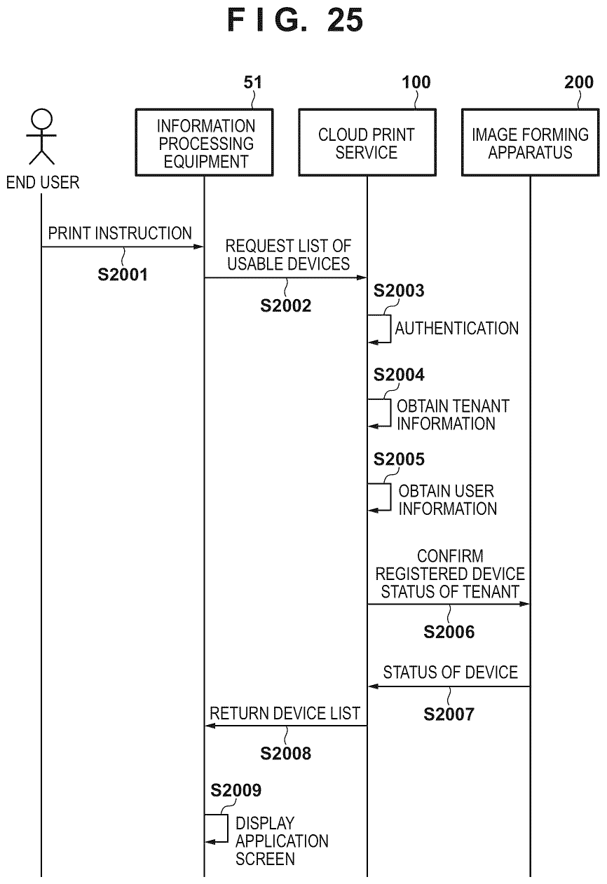

The flow of a sequence in which another example of the screen of the PC application 530, illustrated in FIG. 15, is displayed on the basis of the tenant settings and the user settings will be described next with reference to FIG. 25. This sequence is realized by the information processing equipment 51, the cloud print service 100, and the image forming apparatus 200 executing processing for each other while communicating over the network 10. The processing by the information processing equipment 51 is realized by programs stored in the ROM 514 being read out into the RAM 513 and executed by the CPU 512. Similarly, the processing by the cloud print service 100 is realized by programs stored in the ROM 140 being read out into the RAM 130 and executed by the CPU 120. The processing by the image forming apparatus 200 is realized by programs stored in the ROM 240 being read out into the RAM 230 and executed by the CPU 220.

In step S2001, the PC application 530 of the information processing equipment 51 accepts the selection of the print instruction button 1201 by the end user in a print instruction screen such as that illustrated in FIG. 14. In step S2002, the PC application 530 makes a request for a list of the devices that can be used to the cloud print service 100. At this time, the PC application 530 includes the credentials in the request. Note that if no credentials are present, re-authentication processing may be interposed.

In step S2003, user management 411 of the cloud print service 100 authenticates the user based on the received credentials. In step S2004, if the credentials are determined to be invalid, user management 411 obtains the tenant information illustrated in FIG. 22 from the database 424 on the basis of the information of the tenant to which the user belongs, included in the credentials. In step S2005, user management 411 obtains the user information from the database 424 on the basis of the user information contained in the credentials.

In step S2006, the device management 416 confirms the status of the device belonging to the tenant indicated by the obtained tenant information. Note that if a plurality of devices are present, the confirmation is performed for each device. Note that in step S2006, the information processing equipment 51 may be requested to transmit the status to the device. In step S2007, device management 416 receives the status of the device. Then, in step S2008, device management 416 transmits the device information, including the received status of the device, to the information processing equipment 51. Although not indicated in this sequence, device configuration information/capability information for each device may be included and transmitted in the device information. In step S2009, the PC application 530 of the information processing equipment 51 receives the device information and displays the information in the application screen.

An application screen displayed in the information processing equipment 51 through the processing in FIG. 25 (an example of a “setting screen”) will be described next with reference to FIG. 26. Using the device information transmitted from the cloud print service 100, the PC application 530 displays “Printer B” and “Printer C” corresponding to the “user-used printer” selected by the administrator in the registered device list 1801 indicated in FIG. 21. Note that “Printer B” and “Printer C” are examples of “second information” and “second identification information”. On the other hand, although “Printer A” also belongs to the tenant to which the user belongs (FIG. 23), “Printer A” is not selected by the user, and thus is not displayed in the device designation button 1207. Serial numbers or location information included in the device information may be added to the printer name to make the printer easier to recognize. The device designation button 1207 also displays information 2101 (an example of “third information”) in accordance with a state in which the user cannot use the device or the state in which the device is not operating normally. The information 2101 may also indicate a method through which the device state can be referred to. The information 2101 may also indicate states such as the presence or absence of paper in the device, whether the device is on or off, whether set print settings can be applied to the device, and the like in a recognizable form. The information indicating these device states is included in the device information received by the PC application 530 in step S2009.

Note that if the pull-down display 1202 in the application screen illustrated in FIG. 14 displays specific models, it is assumed that one of the specific models has been selected (e.g., “Printer B”). In such a case, only “Printer B” or a model of the same type may be displayed in the device designation button 1207 illustrated in FIG. 26.

The tenant information in FIG. 23 may also include information indicating a specific user. Then, when a user is authenticated as that specific user in step S2003, the device information included in the tenant with which the specific user is associated may be transmitted to the information processing equipment 51 that transmitted the credentials. In such a case, the device information associated with the specific user is displayed in the device designation button 1207.

### Actions and Effects

According to the image forming system of this variation, an image forming apparatus 200, among the image forming apparatuses 200 included in the tenant, which an administrator has permitted an end user to use, is displayed in an application screen such as that illustrated in FIG. 26. A symbol indicating the state of the image forming apparatus 200 is also displayed. Accordingly, the end user can select the image forming apparatus 200 without needing to be aware of the availability of the image forming apparatus 200. As such, the image forming system according to the variation also improves the usability for the end user executing the printing.

### Other Variations

The application screen displayed in the information processing equipment 51 in step S2009 of the flowchart illustrated in FIG. 25 may be generated by the cloud print service 100. The cloud print service 100 may also include a display, and the application screen may be displayed in the display.

The image forming apparatus 200 registered with the cloud print service 100 in step S608 may also be an image forming apparatus installed by the end user at their home. In such a case, the name of the registered image forming apparatus 200 may be displayed in the screen of the PC application 530 as illustrated in FIG. 15 only when the end user logs in.

In addition, at least one of an image forming apparatus 200 included in the tenant, an image forming apparatus 200 for which the user has checked a checkbox, and the status of an image forming apparatus 200 included in the tenant may be displayed in the screens illustrated in FIGS. 15 and 26. Furthermore, in the screen illustrated in FIG. 26, a list of selected image forming apparatuses 200 is displayed, and the states thereof are displayed for image forming apparatuses not operating normally. However, the configuration may be such that the selected image forming apparatus 200 is displayed but the state thereof is not displayed. The configuration may also be such that all of the image forming apparatuses of the tenant to which the user belongs are subject to the list display, as in the embodiment, and the states thereof are displayed, as in the variation.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-166563, filed Sep. 25, 2024, which is hereby incorporated by reference herein in its entirety.

What is claimed is:

1. An information processing apparatus comprising:
one or more memory devices that store a set of instructions; and
one or more processors that execute the set of instructions to:
obtain user information; and
output information for forming an image, based on the user information obtained,
wherein the information for forming an image includes at least one of first information set in a tenant that includes a plurality of image forming apparatuses and that can be used by a user, second information associated with the user, and third information indicating a state of an image forming apparatus included in the tenant.

2. The information processing apparatus according to claim 1,
wherein the one or more processors execute instructions in the one or more memory devices to:
output information of a setting screen for forming an image, the information including at least one of the first information, the second information, and the third information.

3. The information processing apparatus according to claim 2,
wherein the setting screen:
displays, as the first information, first identification information that is identification information of each of the image forming apparatuses included in the tenant; and
displays whether to temporarily store, in the image forming apparatus, a job instructing the image forming apparatus to form an image, or to designate the first identification information and execute the job in the image forming apparatus corresponding to the first identification information, in a selectable form.

4. The information processing apparatus according to claim 3,
wherein the setting screen displays the second information and the third information,
the second information is second identification information that is identification information of the image forming apparatus, among the image forming apparatuses included in the tenant, selected for display by the user, and
the third information is availability information of this image forming apparatus.

5. The information processing apparatus according to claim 4,
wherein the one or more processors execute instructions in the one or more memory devices to:
perform communication with information processing equipment,
wherein the communication includes obtaining and outputting,
the communication includes, in a case where the user is an administrator, receiving identification information of the image forming apparatus, among the image forming apparatuses included in the tenant, that is selected by the user for display to a specific user, and
the second identification information is this identification information received.

6. The information processing apparatus according to claim 5,
wherein the one or more processors further execute instructions in the one or more memory devices to:
convert first data for forming an image into second data capable of forming an image in the image forming apparatus,
receive the first data from the information processing equipment,
convert the first data received into the second data capable of forming an image in the image forming apparatus included in the tenant, and
transmit the second data to this image forming apparatus.

7. The information processing apparatus according to claim 6,
wherein the one or more processors further execute instructions in the one or more memory devices to:
store one or more items of the second data, and
transmit the second data stored, to the image forming apparatus, in response to a request from the image forming apparatus.

8. An information processing system comprising:
the information processing apparatus according to claim 7; and
the information processing equipment,
the information processing equipment comprising:
one or more memory devices that store a set of instructions; and
one or more processors that execute the set of instructions to:
perform communication with the information processing apparatus; and
display a screen, and
in the information processing equipment,
the one or more processors execute instructions in the one or more memory devices to:
receive information of the setting screen from the information processing apparatus; and
display the setting screen.

9. The information processing system according to claim 8,
wherein in the information processing equipment, the one or more processors further execute instructions in the one or more memory devices to:
accept an input from the user;
in a case where the user is an administrator, display the image forming apparatuses included in the tenant in a selectable form;
accept a selection of the image forming apparatus, among the image forming apparatuses, to be displayed to the specific user; and
transmit the identification information of this image forming apparatus selected to the information processing apparatus.

10. The information processing system according to claim 8, further comprising an image forming apparatus comprising:
one or more memory devices that store a set of instructions; and
one or more processors that execute the set of instructions to:
perform communication and form an image,
wherein in the image forming apparatus, the one or more processors execute instructions in the one or more memory devices to:
receive the second data; and
form an image using the second data.

11. A method for controlling an information processing apparatus, the method comprising:
obtaining user information; and
outputting information for forming an image, based on the user information obtained,
wherein the information for forming an image includes at least one of first information set in a tenant that includes a plurality of image forming apparatuses and that can be used by a user, second information associated with the user, and third information indicating a state of an image forming apparatus included in the tenant.
